(19) United States
(12) Patent Application Publication
(10) Pub. No.: US 2009/0279193 A1
(43) Pub. Date: Nov. 12, 2009

(54) METHOD AND APPARATUS FOR MOUNTING SENSORS IN FRAMES

(76) Inventor: Clyde B. Jones, Crab Orchard, KY (US)

Correspondence Address: ROBERT R. WATERS, ESQ.;WATERS LAW OFFICE, PLLC, 633 SEVENTH STREET, HUNTINGTON, WV, 25701, US

(21) Appl. No.: 12/505,970

(22) Filed: Jul. 20, 2009

Related U.S. Application Data
(63) Continuation-in-part of application No. 12/106,787, filed on Apr. 21, 2008, now Pat. No. 7,573,018.

(51) Int. Cl. G02B 7/02

(52) U.S. Cl. 359/827

(57) ABSTRACT

Cables and sensor lenses are routed through the frame to which they are to be mounted. At each location where a sensor is to be mounted, the remaining sensors are routed behind the mounting block at that location to continue on to other locations. Routing the sensors and cables through the frame offers protection to the sensors and cables without installing additional conduit and routing the sensors and cables behind the mounting block maintains a clear line of sight for the sensor lenses. The mounting blocks and sensor lenses may be located at least partially within the frame.

### RELATED U.S. APPLICATION DATA

This application claims priority from U.S. Provisional Application 60/684,330, filed on May 25, 2005 and U.S. patent application Ser. No. 11/440,496. The entire disclosure contained in U.S. Provisional Application 60/684,330, and U.S. patent application Ser. No. 11/440,496, including the attachments thereto are incorporated herein by reference.

### FIELD OF THE INVENTION

This invention relates generally to mounting sensors. More specifically, this invention relates to mounting optical sensors in harsh environments.

### BACKGROUND OF THE INVENTION

In many types of industrial production, sensors are used for monitoring equipment in the production plant, equipment as it moves through the production plant, production items as they move through the production plant, and for other purposes as well. Frequently, optical sensors are the sensor of choice and they are used to count or monitor production items on a conveyor or production line. For example optical sensors may be used to monitor and count poultry in a poultry processing plan. Some optical sensors use a central controller to generate a light beam and send it over an optical cable to a sending lens. An aligned receiving lens receives the light beam which is directed over an optical cable back to the controller which monitors the status of the beam. Other optical sensors may use a central controller to power and monitor remote light beam generators and receivers. In these, a controller powers a remote light beam generator and a remote light beam receiver. The light beam receiver sends signals back to the controller regarding beam status. Other arrangements may also be used. Whether the optical sensor is one that uses optical cables or electrical cables, the cables must be routed from the controller to the remote optical element. Typically, electrical conduit is installed specifically for the purpose of routing these cables, and this is an added expense. The conduits themselves can be overly prominent and subject to damage.

In a typical poultry processing plant, a conveyor runs through the various sections of the plant. In some parts of the plant, the chicken or carcass hangs down from the conveyor on a shackle, while in other parts of the plant, a chicken carcass is supported from a conveyor below with a cone or similar carrier. The conveyor moves continuously at a fairly high rate of speed, and at some initial point on the lines, the chickens are manually hung from shackles hanging from the conveyor or placed on cones on the conveyor. As with any processing plant, it is important to track inputs and know where, and at what stage, productivity losses occur. Because the conveyor runs continuously, and is loaded manually and continuously, it is hard to maintain an accurate count of chickens processed. Even if an accurate count of the chickens loaded is managed, as the conveyor progresses through the plant, chickens and chicken carcasses may fall from the conveyor for various reasons. These reasons include inadequate initial hanging of the chicken, flailing about of the chicken, entanglement of adjoining chickens and shackles, unbalanced placement on the cones, and interaction of processing equipment and workers with the chickens. Therefore, in addition to an initial count of chickens placed on the conveyor, it is desirable to monitor the conveyor at various points in the plant to know where any deviations between input and output originate. Because optical sensors can monitor for objects without having to contact the objects, and, indeed, can monitor at some distance from the objects, optical sensors are frequently the choice for performing the monitoring function.

While optical sensors are good candidates because of their capabilities, many production environments are extremely harsh. In the example of poultry processing plants, drifting feathers and other dirt, splashing water and other fluids, and even steam from periodic cleaning of equipment contribute to creating an extremely harsh environment for optical sensor system. As mentioned above, the electrical conduit usually installed to route and protect the optical sensor cables can be expensive to install and vulnerable to damage once installed. The present invention provides protection for the sensors while minimizing external cable routings and provides ease of access and maintenance for the sensors.

### DESCRIPTION OF THE PRIOR ART

U.S. Pat. No. 5,646,398 by Sieksmeier et al. is directed to counting hangers being carried on a conveyer. The conveyor may be the type of conveyer that carries longer bars with the bars carrying the hangers, or it may be a more continuous chain type conveyer where the segments are somewhat small. Sieksmeier uses optical light beams distributed in pairs along a vertical line. The vertical pairs allow the detection of which direction the object is traveling by which optical beam of the pair is interrupted first. The use of pairs of optical sensors along a vertical line also provides means for detecting hangers which have become tangled and are crossed over, and for counting that situation as two hangers as opposed to one. For example, sensors at the top of the lines of sensors may detect only one hanger where the hangers are crossed over each other, but sensors lower in the line of sensors will see two hangers, because at that point, the profile of the tangled hangers will be wider or even separated into two hangers again, allowing the pattern of optical beam interruption to be interpreted as two hangers. A microprocessor unit or other such unit is electronically interfaced with the array of optical light beam sensors and is able to interpret the signals received to distinguish the direction of the hangers, whether or not one or two hangers are present at a particular point, and to provide a total count of hangers carried by the conveyor.

U.S. Pat. No. 5,033,065 by Keromnes et al. is directed to an invention for counting objects having poorly defined shapes, or living animals. The invention is applied to situations using a conveyor to conduct the objects, or living animals, through a process situation. The essential aspect of the invention is a number of optical light beam sensors lined up with each other to define a monitored space. On one side of the monitored space are a line of sensors emitting light, and on the other side of the space are the parts of the sensors intended to receive the light. As an object passes down the conveyor and through this line of light beams, some number of light beams will be disrupted and generate distinct deduction impulses. A comparator counts the number of deduction impulses received and compares that number to a preset value. When the preset value is exceeded, a counting impulse is emitted by the system and an increment is added to the count. An aspect of the preferred embodiment is that infrared beams are used in the array of optical light beam sensors to avoid interference from ambient light. Generally, the array of sensors define a space to be monitored, and when a sufficient number of light beams of the array is interrupted, it is deemed that an object is passing through and an increment is added.

U.S. Pat. No. 7,219,729, by Bostick, III, et al is for Permanent downhole deployment of optical sensors. The invention involves methods and apparatus for permanent downhole deployment of optical sensors. Specifically, optical sensors may be permanently deployed within a wellbore using a casing string. In one aspect, one or more optical sensors are disposed on, in, or within the casing string. The optical sensors may be attached to an outer surface of the casing string or to an inner surface of the casing string, as well as embedded within a wall of the casing string. The optical sensors are capable of measuring wellbore parameters during wellbore operations, including completion, production, and intervention operations.

U.S. Pat. No. 6,496,273 B1, by Stimpson et al., is related to machine tooling and coordinate positioning of tooling in machining, or other processes. Stimpson uses a light beam to delineate a specific position with respect to the machine and when the tool or other object breaks the light beam, the machine then knows the position of the object or tool. The position determining apparatus uses a beam emitter and a beam receiver. To keep these clean, they are mounted within housings having apertures aligned with each other. The beam passes through the apertures from the emitter to the receiver. Internal to the housing is a cavity which is kept at positive air pressure. The positive air pressure is maintained by introducing filtered compressed air into the housing and only allowing air to flow out of the apertures, thereby preventing any dust or other debris from passing into the housing through the aperture and covering, or otherwise limiting, the efficiency of the light beam.

### SUMMARY DESCRIPTION OF EMBODIMENTS

The present invention is directed to mounting a series of optical sensors in a highly protected manner. Optical sensors typically comprise a controller, a light beam sending lens, a light beam receiving lens, and cables connecting the sending and receiving lens to the controller. If the light beam is created at the controller, then the cables are optical cables. If the light beam is generated at the sending lens, then the cables are electrical cables. In the former case, the controller generates the light beam and directs it over the optical cable, the light beam passes from the sending lens to the receiving lens back up a return cable, and the controller monitors the status of the light beam to monitor the space between the lenses. In the latter case, a beam generator at the sending lens generates a light beam which is directed to the receiving lens, electronics at the receiving lens monitor the light beam and creates an electrical signal based on the status of the light beam and sends the signal to the controller, and the controller monitors the signal to monitor the space between the lenses. Some applications may mount the sending and receiving lenses side by side and mount a reflector across from the lenses to provide the needed path between the sensors.

To mount multiple sensors, sections of tubing are placed on opposite sides of a space to be monitored by the optical sensors. At locations where the sending or receiving lenses of an optical sensor are to be mounted, a view aperture and an access aperture are cut through the wall of the sections of tubing, and a mounting block is placed at that location to hold the lens or lenses that will be mounted there. For example, if the sections of tubing are oriented vertically, then at the heights where optical sensors are to be mounted, view apertures and access apertures are cut through the wall. The view aperture faces the space that is to be monitored by the optical sensor, and the access aperture is generally aligned with the respective view aperture. The access aperture can give additional space for cables as well as give access to the mounting block. The view aperture need not be the same size as the access aperture, since the first purpose of the view aperture is to allow the light beam passage through the wall of the tubing. In some embodiments, particularly where the section of tubing provides adequate room, only a view aperture may be cut through the wall of the sections of tubing at a given location. In those embodiments, in particular, a cover plate is used.

To avoid installing external conduit in which to route the cables, the cables are routed, at least partially, inside the tubing. When the cables come to a view aperture and mounting block, a selected lens or lenses are mounted in the mounting block and the other cables and attached sensor elements are routed behind the mounting block to preserve the line of sight of the lens or lenses mounted in the mounting block.

In embodiments having access apertures, the cables may be routed out through the access aperture and behind the mounting block and sensors mounted in the mounting block. The remaining cables and sensor elements are routed back into the tubing. Spacing between the edge of the mounting block and the access aperture where the cables exit and enter the tubing allow for this routing of the cables. The process is repeated at each location where a lens for an optical sensor is to be mounted. In some embodiments, bypass notches are cut in the respective edges of the access apertures to ensure adequate space for the cables to route out of the tubing and back into the tubing around the mounting block.

Some embodiments of the invention will employ view apertures in the tubing that approximate the size of the access apertures. This may be done for a variety of reasons including ease of manufacture and to provide easier access to the inside of the tubing for maintenance and other reasons. In the cases where a larger view aperture is employed, a cover plate is placed over the view aperture to avoid having an excessively large opening to the environment. The cover plate itself has a sight aperture through it to allow the light beam of the optical sensor to pass through the cover plate and the wall of the tube. The cover plate may be attached to the tubing with screws, or other common methods may be used. Some embodiments will also employ a protective covering box attached to the tubing and covering the access apertures, mounting blocks, lenses in the mounting blocks, and the cables bypassing the mounting blocks on the outside of the tubing. These boxes protect the mounting blocks, lenses, and cables, and are removable to allow access for installation of the mounting blocks, routing of cables and later access for maintenance and other purposes. Some embodiments will employ a fastener such as a bolt between cover plates and mounting blocks to connect the two, and if the cover plate is attached to the tubing with screws or other means, then the cover plate and bolt provide a mounting bracket for the mounting block. The mounting block may be partially or wholly located within the tubing.

In embodiments where the tubing provides adequate space, a view aperture alone may be used with a cover plate. The mounting block at a given location is removably attached to the cover plate which is removably attached to the tubing. The sensors and cables are routed through the tubing to the view aperture and mounting block where the appropriate lens is mounted. The remaining lens and cables are routed behind the mounting block to proceed to the next location.

Finally, some embodiments will maintain a positive air pressure in the tubing to create an outflow of air at any apertures to the outside of the tubing. This can be done with a blower providing filtered air to the tubing. Air outflow at the apertures prevents excessive dirt from entering at the apertures.

As discussed above, the method and device of the present invention overcomes the disadvantages inherent in prior art methods and devices. In that respect, before explaining at least one embodiment of the invention in detail, it is to be understood that the invention is not limited in its application to the details of construction and to the arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. While the embodiments discussed in this application may be discussed with reference to use in a poultry processing plant, it is not limited to poultry processing plants, but rather, it should be understood that anyplace where similar sensors may be used, the invention can find applicability.

Accordingly, those skilled in the art will appreciate that the conception upon which this invention is based may readily be utilized as a basis for the design of other structures, methods, and systems for carrying out the several purposes of the present invention. It is important, therefore, that the claims be regarded as including such equivalent constructions insofar as they do not depart from the spirit of the present invention.

Furthermore, the purpose of the foregoing Abstract is to enable the U.S. Patent and Trademark Office and the public generally, and especially including the practitioners in the art who are not familiar with patent or legal terms or phraseology, to determine quickly from a cursory inspection, the nature and essence of the technical disclosure of the application. The Abstract is neither intended to define the invention of the application, nor is it intended to be limiting to the scope of the invention in any way.

### BRIEF DESCRIPTION OF THE DRAWINGS

Additional utility and features of the invention will become more fully apparent to those skilled in the art by reference to the following drawings, which illustrate the primary features of the several embodiments of the present invention.

FIG. 1 shows an in-line view of a prior art method of mounting optical sensors.

FIG. 2 shows a back view of a prior art method of mounting optical sensors.

FIG. 3 is an end view of another prior art method of mounting optical sensors.

FIG. 4 shows the pocket cut-outs for the prior art method of mounting optical sensors.

FIG. 5 shows the mounting plate and cover plate for the prior art method of mounting sensors.

FIG. 6 is an in-line view of optical sensors mounted with an embodiment of the present invention.

FIG. 7 shows a back view of optical sensors mounted with an embodiment of the present invention and protected by covers.

FIG. 8 is an enlarged view of optical sensors mounted with an embodiment of the present invention.

FIG. 9 shows frame tubing with apertures and other elements of an embodiment of the present invention.

FIG. 10 shows a side view of lenses mounting with an embodiment of the present invention and elements of the embodiment in an exploded side view.

### DETAILED DESCRIPTION OF EMBODIMENTS

The detailed description below of certain embodiments is intended to explain the current invention. It is to be understood that a variety of other arrangements are also possible without departing from the spirit and scope of the invention. The initial part of the detailed description will discuss prior art and refer to figures illustrating the prior art.

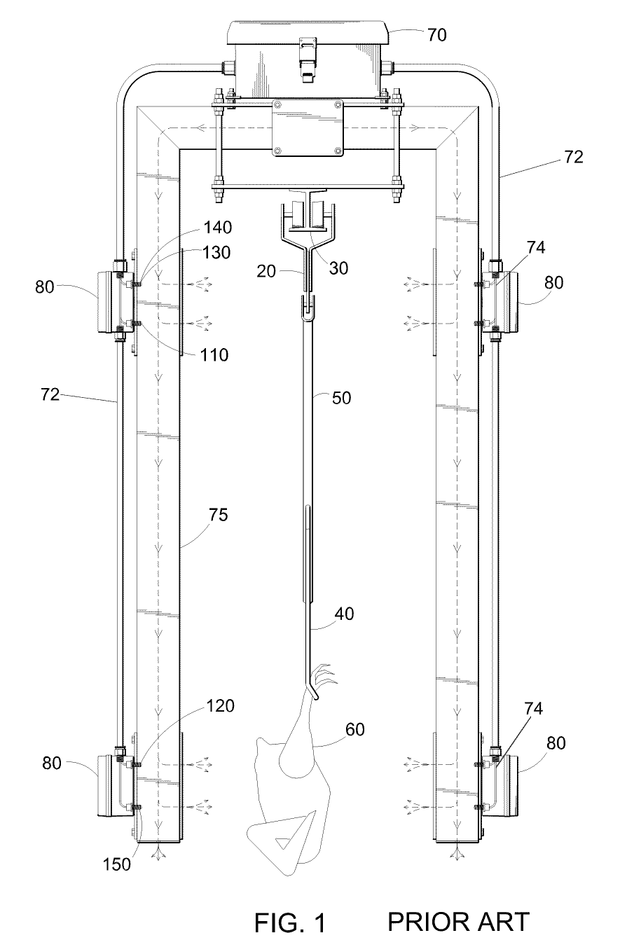

FIG. 1 shows an in-line view of a prior art method of mounting optical sensors. In this particular example, the sensors are mounted on and in a frame of hollow tubing 75 straddling a conveyor in a poultry processing plant. Optical sensor lenses 110, 120, 130, 140, and 150 are mounted at the outside wall of the tubing frame and directed to the inside wall of the hollow tubing frame 75. Optical sensor lenses complimentary to optical sensors lenses 110, 120, 130, 140, and 150 are mounted opposite to them in the other leg of the frame of hollow tubing 75. Likewise the complimentary sensors are mounted at the outside wall of the tubing frame 75 and directed to the inside wall of the tubing frame. Apertures through the inside wall allow light beams associated with the optical sensors to pass through the inside walls of the hollow tubing frame to monitor the space between the two sections of frame.

Still referring to FIG. 1, control box 70 is mounted on frame of hollow tubing 75. Within control box 70 are optical sensor controllers associated with optical sensor lenses 110, 120, 130, 140, and 150. Conduit 72 runs from control box 70 to junction boxes 80 mounting on the outside wall of frame of hollow tubing 75. Junction boxes 80 cover the optical sensor lenses mounted in the frame of hollow tubing 75. Cables 74 are routed through conduit 72 into junction boxes 80 and on into the back of optical sensor lenses 110, 120, 130, 140, and 150 and their complimentary sensor lenses. As may be seen in FIG. 1, the approach of cables 74 from the back of the optical lenses prevents cables 74 from obstructing the line of sight of the lenses. In the embodiment shown in FIG. 1, cables 74 are optical cables. The light beam is generated in the controllers control box 70, out and back along cables 74, and is directed across the space to be monitored by lenses 110, 120, 130, 140, and 150 their compliments. The blocked or unblocked status of the light beam is monitored back at the controller.

Located in control box 70, each sensor's controller generates the light beam and checks its blocked or unblocked status. The light beam is directed from the sensor controller through optical fibers to a remote sending lens where the light beam exits to travel across a space to be monitored. On the opposite side of the space to be monitored is a receiving lens aligned with the sending lens to receive the light beam. Upon entering the receiving lens, the light beam enters an optical fiber, or cable, which conducts it back to the sensor controller. When an object is between the sending lens and the receiving lens, the light beam is blocked, and the controller does not receive the return signal when it checks the status of the light beam. The controller interprets the light beam status using logic and generates signals for the larger system based on the status of the light beam.

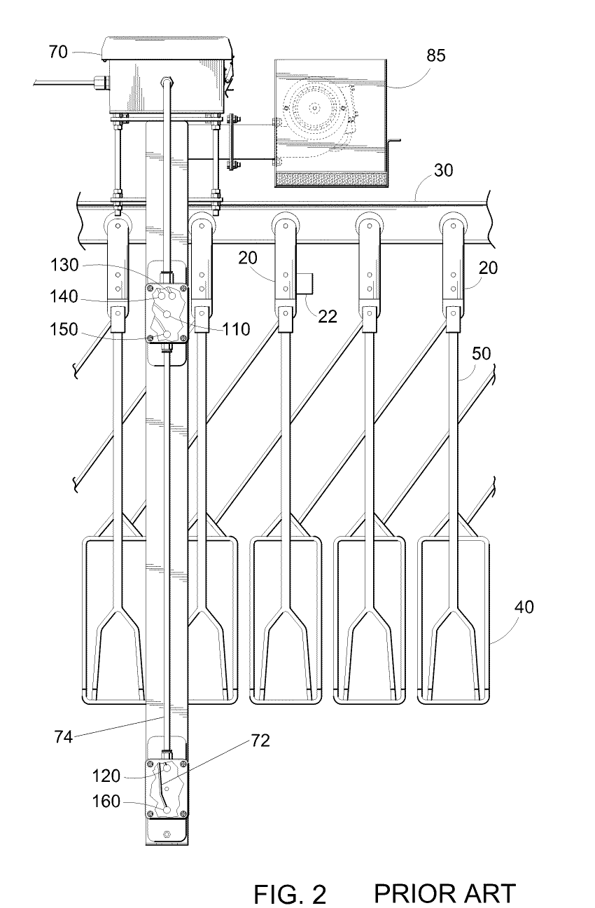

FIG. 2 shows a back view of a prior art method of mounting optical sensors. Parts of junction boxes 80 are shown cut away to expose cables 72 and conduit 74 is visible in FIG. 2 as well. Also show in FIG. 2 is blower 85 which is ducted to hollowing tubing 75 and keeps hollow tubing 75 at a positive air pressure. Referring back to FIG. 1, the dotted lines with arrows inside hollow tubing 75 indicate the flow of air through hollow tubing 75 and out the various apertures.

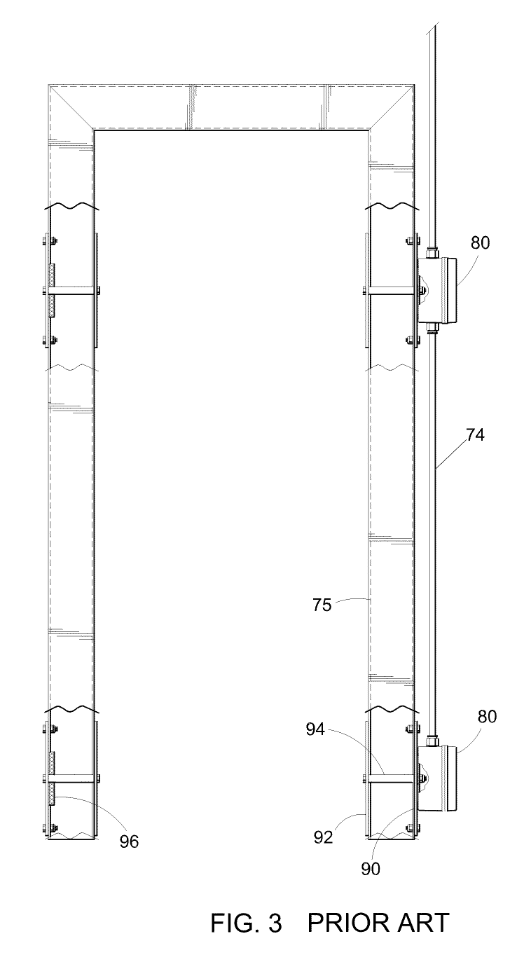

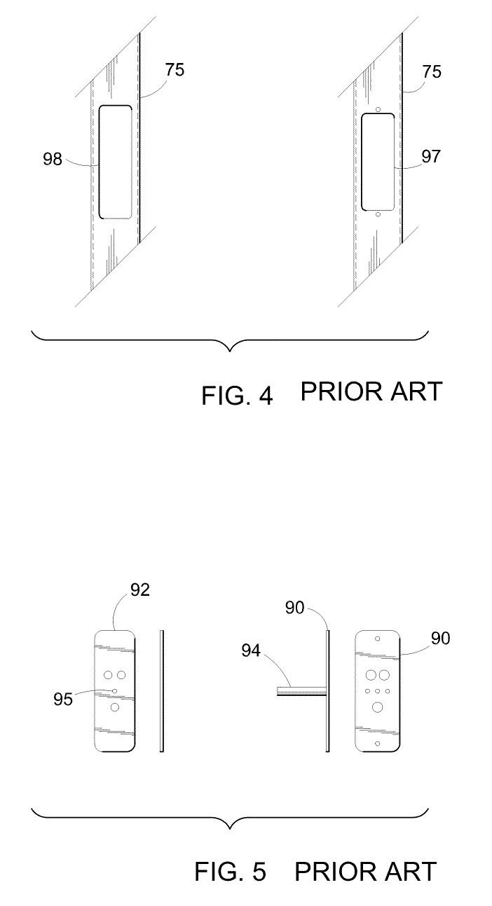

Referring to FIGS. 4 and 5, which show elements of the prior art method and apparatus of mounting optical sensor lenses of FIGS. 1-3, FIG. 4 shows the cutouts in the frame where the sensors are mounted and through which the optical light beams pass. The wall of the tubing opposite the conveyor is the outer wall and has mounting plate cutout 97 and screw holes 99 above and below mounting plate cutout 97 to accept screws passing through frame 75. This is how mounting plate 90 is held onto frame 75. There are also screw holes in the mounting plate 90 which match those in the junction boxes 80 that hold the sensor elements, and that is how the junction boxes 80 are held to mounting plates 90. In FIG. 3, cover plate post 94 fixed to mounting plate 90 extends through the interior of tube frame 75 to the inside wall of frame 75 where the end of cover plate post 94 is flush with the surface of the frame 75. A tapped hole in the end of the cover plate post 94 receives a screw which passes through cover plate 92 and clamps cover plate 92 to cover plate post 94 and tube 75. Cover plate 92 has apertures through which the optical light beams may pass, whether the sending unit and receiving unit are located on opposite sides of the frame, or whether a reflector is used. By attaching cover plate 92 to mounting plate 90 that holds the sensors, the sensors may be repositioned for alignment with their counterpart on the other side of the frame by moving mounting plate 90. Cover plate 92 will move with the adjustment so that the line of sight through cover plate 92 will be maintained. Cover plate 92 limits exposure of the inside of the frame 75, while allowing easy access for periodic cleaning of the sensors without their removal, which would require realignment. While the illustrated embodiments uses a post that receives a screw, alternatively, the post could be a threaded stud protruding through the cover plate, and a nut could clamp the cover plate against frame.

While the prior art as illustrated in FIGS. 1-5 provides mounting and protection for the optical lenses and their respective cables, the prior art requires conduit to be installed which is an added expense and also is itself susceptible to damage. The embodiments of the present invention provide protection to the sensors and cables without the need for conduit and the attendant costs. The embodiments of the present invention accomplish this by routing the cables for the sensors through the frame tuning itself. To route the cables and sensors lenses through the tubing, additional adaptations are made to insure that the cables for the sensor lenses do not block the line of sight of the sensor lenses.

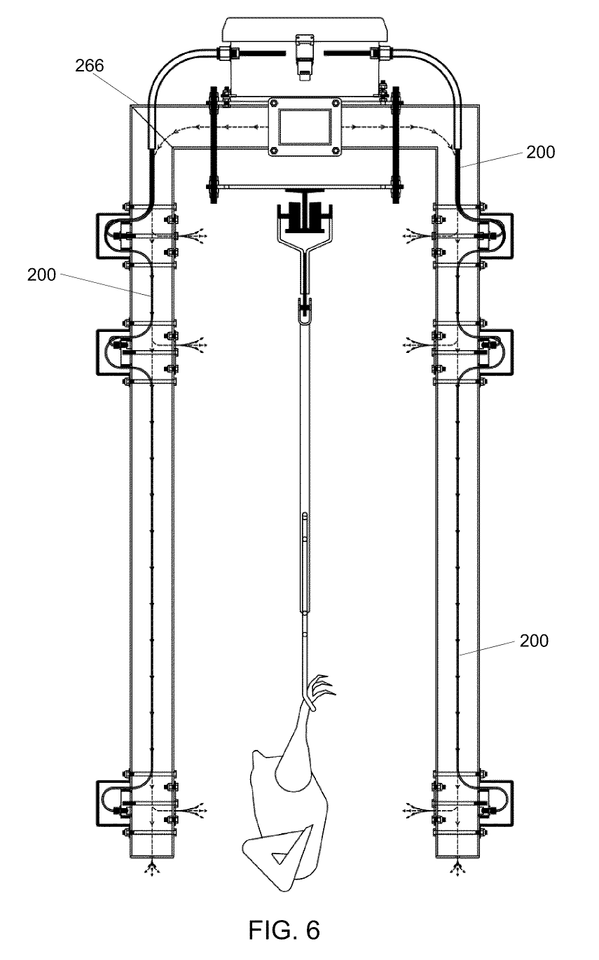

Referring now to FIG. 6, FIG. 6 is an in-line view of optical sensor lenses mounted with an embodiment of the present invention. The optical sensor lenses are mounted on a frame of hollow tubing which straddles a conveyor. The optical sensor lenses are arranged to monitor the space straddled by the frame and thereby the conveyor.

In FIG. 6, cables 200 for optical sensor lenses 202 are routed from control box 204 into frame tubing 206. In FIG. 6, for a short distance, cables 200 run through a section of conduit 208 to get from control box 204 to frame tubing 206. Other arrangements may be made for getting cables 200 from control box 204 into frame tubing 206, particularly when control box 204 is mounted directly on a section of frame tubing contiguous with the frame tubing where sensor lenses 202 will be mounted. In that case, cables 200 may pass directly from control box 204 into frame tubing 206.

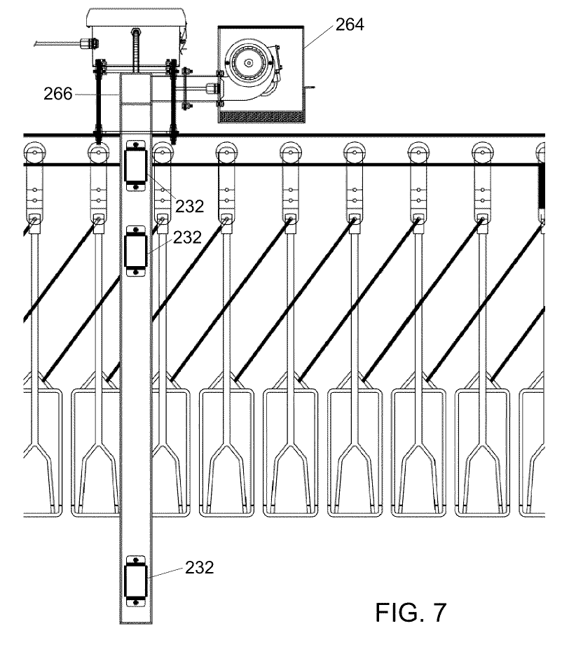

At the locations 210 where sensor lenses 202 are to be mounted, a pair of apertures are formed through frame tubing 206. This pair of apertures begins with a view aperture 214 through the wall of frame tubing 206 facing the space to be monitored and passes through frame tubing 206 to an access aperture 212 through the wall of frame tubing 206 opposite to the space to be monitored. Mounting blocks 216 with at least one lens mount 218 through them are located on frame tubing 206 at least partially covering access aperture 212 and may be at least partially located within frame tubing 206. Lens mounts 218 are sized and shaped to receive and hold a sensor lens 202. View apertures 214 are large enough and sufficiently lined up with lens mounts 218 to allow a light beam to pass from a lens 202 through frame tubing 206 and out view aperture 214 across the space to be monitored. Protective box shaped covers 232 are mounted on frame tubing 206 over access apertures 212 and mounting blocks 216. FIG. 7 shows a back view of optical sensors mounted with an embodiment of the present invention and protected by covers 232.

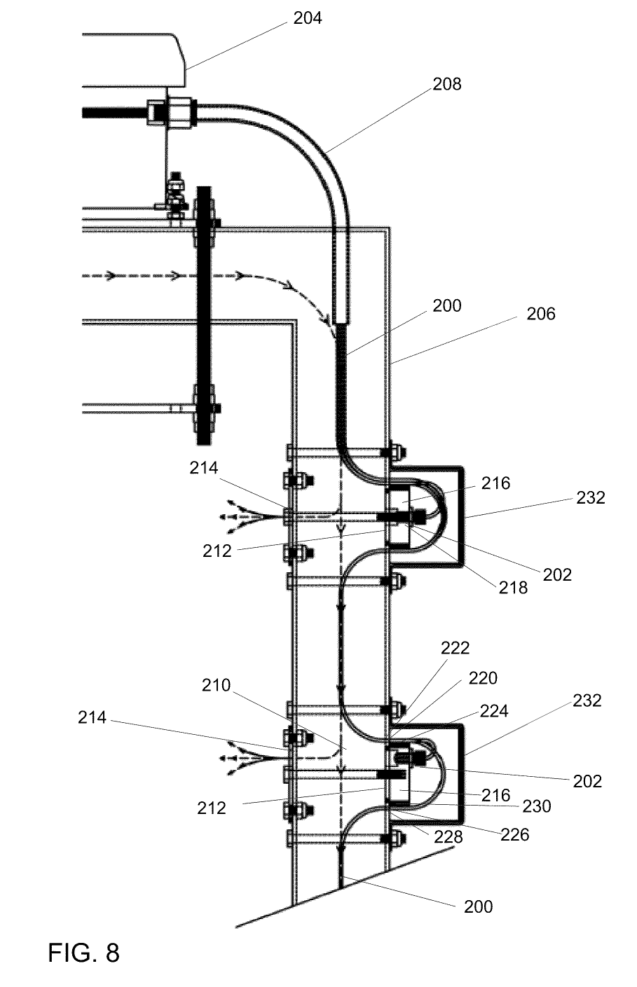

FIG. 8 is an enlarged view of optical sensors mounted with an embodiment of the present invention. FIG. 8 is an enlarged view of frame tubing 206 similar to that shown in FIG. 6. In the following description of embodiments of the invention, reference may be had to FIG. 8 as well as FIG. 6.

As cables 200 with sensor lenses 202 are routed through frame tubing 206, when they arrive at a sensor mounting location 210, cables 200 and optical sensor lenses 202 are routed out of frame tubing 206 through a first space 220 between the nearest edge 222 of access aperture 212 and the respective edge 224 of mounting block 216. The desired lens 202 is selected from among those lenses being installed and it is mounted in lens mount 218 in mounting block 216. The remaining cables 200 and associated lenses 202 are routed behind mounting block 216 and back into frame tubing 206 through a second space 226 between the farthest edge 228 of access aperture 212 in frame tubing 206 and the respective edge 230 of mounting block 216. This short routing of cables 200 out of frame tubing 206 and behind mounting block 216 prevents cables 200 from obstructing the line of sight of a lens 202 mounted in the particular mounting block 216. The term nearest edge 222 of access aperture 212 is intended to mean the first edge of access aperture 212 that is encountered as cables 200 are traced or routed through frame tubing 206 from a particular direction and the term farthest edge 228 of access aperture 212 is intended to mean the second edge of access aperture 212 that is encountered as cables 200 are traced or routed through frame tubing 206 from a particular direction. These terms are dependent on the direction along which the cable is routed, or traced, and therefore are essentially interchangeable, depending on that direction.

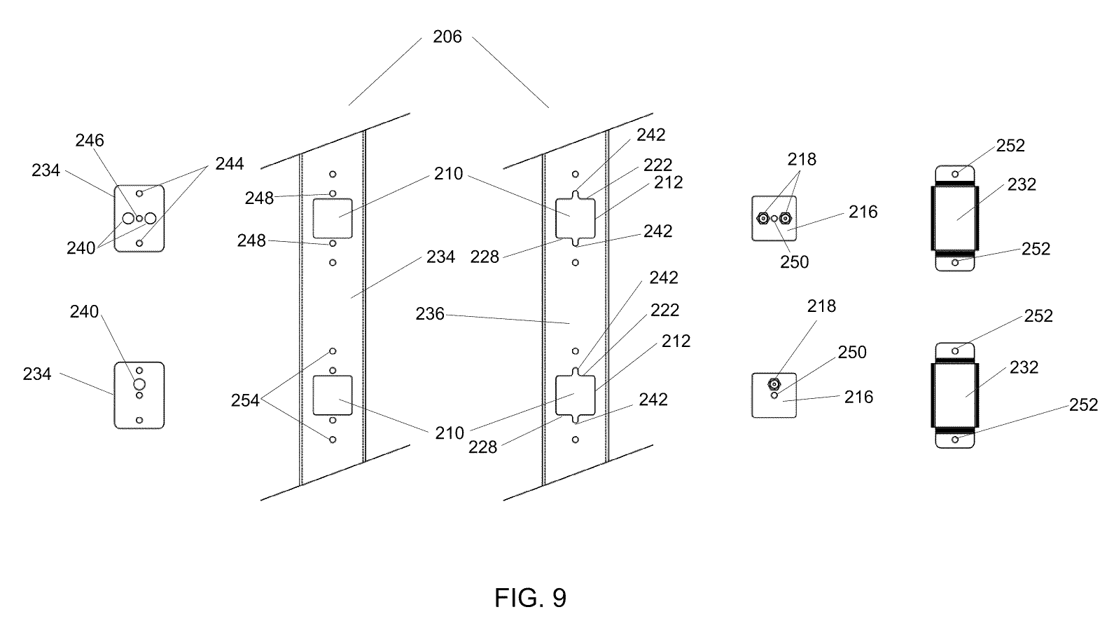

Referring now to FIG. 9, FIG. 9 shows elements of an embodiment of the invention where view aperture 214 is approximately the same size as access aperture 212 and a cover plate 234 is placed over view aperture 214. FIG. 9 shows both the side 236 of frame tubing 206 that faces the space to be monitored and the side 238 of frame tubing 206 away from the space to be monitored. Along with framing tube 206, FIG. 9 shows mounting blocks 216, cover plates 234, and covers 232. The sides of mounting blocks 216, cover plates 234, and covers 232 are the sides that would be seen when they are mounted and the resulting assembly is viewed from that side of frame tubing 206.

In the embodiment of FIG. 9 view apertures 214 are approximately the same size as access apertures 212 and the two types of apertures are approximately aligned across respective sensor mounting locations 210. Cover plates 234 are sized to cover view apertures 214 and therefore have sight apertures 240 through them which align with lens mounts 218 in mounting blocks 216 when cover plates 234 and mounting blocks 216 are mounted on frame tubing 206. Sight apertures 240 in cover plates 234 allow a light beam to pass from a lens 202 through frame tubing 206 and out sight aperture 240 across the space to be monitored.

In FIG. 9, access apertures 212 have bypass notches 242 in their nearest edges 222 and their farthest edges 228 of their perimeters. In the embodiment of FIG. 9, bypass notches 242 provide the first space 220 and second space 226 described with respect to the embodiment in FIG. 8 through which cables 200 can be routed behind mounting block 216. The relevant edges of the access apertures in FIG. 9 are numbered as if the nearest edges occur as approached from the top, but this is only a convention for numbering purposes.

More than one sensor lens may be mounted at a given mounting block 216. As may be seen in FIG. 9, the top mounting block 216 in FIG. 9 has two lens mounts 218 for mounting more than one lens 202. The top cover plate 234 in FIG. 9 has two sight apertures 240 matching the lens mounts 218 of its respective mounting block 216.

Several fastener apertures may be seen in FIG. 9. Cover plates 234 have fastener apertures 244 as well as fastener aperture 246. Fastener apertures 244 in cover plates 234 match fastener apertures 248 in frame tubing 206 and provide a method of affixing cover plates 234 to frame tubing 206. In the embodiment shown in FIG. 9, fastener apertures 246 in cover plates 234 match fastener apertures 250 in mounting blocks 216 and facilitate the mounting of mounting blocks 216 to frame tubing 206 by providing a means of affixing mounting blocks 216 to cover plates 234 which are affixed to frame tubing 206. Other embodiments may employ different methods of fixing mounting blocks 216 in place. Covers 232 have fastener apertures 252 through them which match fastener apertures 254 through frame tubing 206. Fastener apertures 252 and 254 provide a method of affixing covers 232 over access apertures 212 and mounting blocks 216.

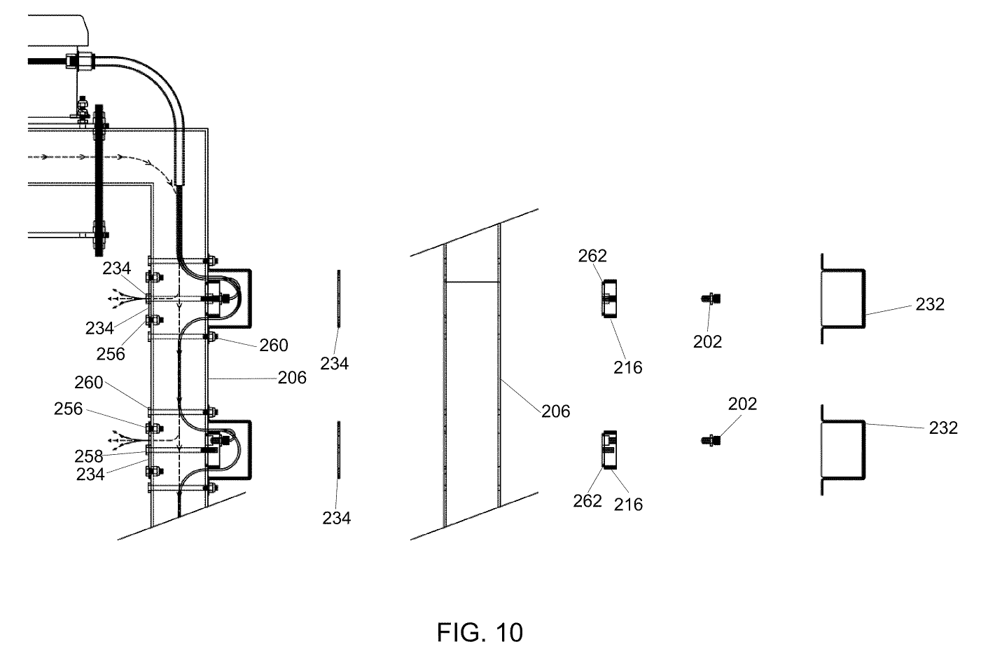

FIG. 10 shows a side view of an embodiment of the invention of this application and elements of the embodiment separated from each other. Sensor lenses 202 are also shown in FIG. 10 to illustrate the alignment of sensor lenses 202. In the application shown at the left of FIG. 10, fasteners 256 are shown attaching cover plates 234 to frame tubing 206. With cover plates 234 affixed to frame tubing 206, fastener 258 affixes mounting block 216 to cover plate 234, and thus positions mounting block 216 and access aperture 212. Fasteners 260 pass through frame tubing 206 through apertures 254 and apertures 252 to affix covers 232 to frame tubing 206.

In FIG. 10, mounting blocks 216 have shoulders 262 cut in their circumferences on the face oriented toward frame tubing 206. Shoulders 262 allow mounting blocks 216 to be at least partially mounted inside framing tubes 206.

Referring to both FIG. 9 and FIG. 10, it can be seen that access apertures 212 in mounting blocks 216 and sight apertures 240 in cover plates 234 can be varied as needed at a given location. The upper location in both FIGS. 9 and 10 mounts two lenses 202, while the lower location in FIGS. 9 and 10 mount a single lens 202. In each case, sight apertures 240 are positioned to align with lens mounts 218. In the upper location, lens mounts 218 are at the same height, or level, as fastener apertures 250 in mounting block 216 and fastener aperture 346 in cover plates 234. In the lower location, lens mount 218 is offset from the level or height of fastener apertures 250 in mounting block 216 and fastener aperture 246 in cover plate 234. In both cases, the upper location and the lower location, this alignment of lens mounts 218 with respect to fastener apertures 250 and 246 is a matter of selection for a given application and should not be taken as a limiting element of the current invention.

Referring back to FIG. 7, blower 264 is mounted at the top of a frame 266 made from frame tubing 206. Blower 264 is ducted into frame tubing 206 and maintains frame tubing 206 at a positive air pressure to ensure that air is flowing out of any apertures in frame 266. This keeps dirt and debris from drifting into the various apertures. FIGS. 6, 8, and 10 illustrate the flow of air through frame tubing 206.

It should be appreciated that the current invention could be applied with other variations in the particular sensing hardware. For example, the optical sensor could use a reflector to bounce back a light beam or be a diffuse optical sensor. FIG. 3 shows a prior art system utilizing reflectors 96 on the left of tubing frame 75 while both a sending and receiving lens are mounted in junction boxes 80 on the right side. Again, conduit 74 guides cables 72 to junction boxes 80. Embodiments of the present invention could be applied to that situation as well to address problems of the prior art.

It is to be understood that the embodiments and claims are not limited in application to the details of construction and arrangement of the components set forth in the description and illustrated in the drawings. Rather, the description and the drawings provide examples of the embodiments envisioned, but the claims are not limited to any particular embodiment or a preferred embodiment disclosed and/or identified in the specification. The drawing figures are for illustrative purposes only, and merely provide practical examples of the invention disclosed herein. Therefore, the drawing figures should not be viewed as restricting the scope of the claims to what is depicted.

The embodiments and claims disclosed herein are further capable of other embodiments and of being practiced and carried out in various ways, including various combinations and sub-combinations of the features described above but that may not have been explicitly disclosed in specific combinations and sub-combinations. Accordingly, those skilled in the art will appreciate that the conception upon which the embodiments and claims are based may be readily utilized as a basis for the design of other structures, methods, and systems. In addition, it is to be understood that the phraseology and terminology employed herein are for the purposes of description and should not be regarded as limiting the claims. Also, while the sensors at the various locations are generally aligned, this alignment need not be precise.

I claim:

1. A system for mounting a series of at least two sensor lenses wherein each said sensor lens has a cable leading to said lens, said system of mounting said sensor lenses comprising;
a section of frame tubing, said section of frame tubing having at least two view apertures in it;
a cover plate for each said view aperture, each said cover plate being removably attached to said section of frame tubing and at least partially covering said view aperture and said cover plate having at least one sight aperture;
a mounting block removably affixed to each said cover plate, each said mounting block having a lens mount for each said lens to be mounted in each mounting block, said lens mount for each said lens aligning with a sight aperture in said cover plate, and each said mounting block being positioned at least partially within said section of frame tubing.

2. The system for mounting a series of at least two sensor lenses of claim 1, further comprising;
an access aperture in said section of frame tubing for each said view aperture, each said access aperture being located on the opposite side of said section of frame tubing from the respective view aperture.

3. The system for mounting a series of at least two sensor lenses of claim 2, further comprising;
a cover for each said access aperture, said cover being removably attached to said section of frame tubing and covering said access aperture.

4. The system for mounting a series of at least two sensor lenses of claim 1, wherein;
said section of frame tubing is maintained at a positive air pressure to ensure outward airflow at any apertures.

5. A system for mounting a series of at least two sensor lenses wherein each said sensor lens has a cable leading to said lens, said system of mounting said sensor lenses comprising;
a section of frame tubing, said section of frame tubing having, at each location where at least one sensor is to be mounted, a view aperture and an access aperture generally aligned opposite to said view aperture;
a mounting block for each location where at least one sensor is to be mounted, each said mounting block having a lens mount for each said lens to be mounted in each said mounting block and each said mounting block being positioned at said access aperture with a first space between a first edge of said mounting block and a first edge of said access aperture and a second space between a second edge of said mounting block and a second edge of said access aperture, each of said first space and said second space sufficient to accommodate the optical cables of said series of at least two optical sensor lenses.

6. The system of mounting a series of at least two optical sensor lenses of claim 5, further comprising;
a first bypass notch in said first edge of said access aperture creating said first space and a second bypass notch in said second edge of said access aperture creating said second space, said first bypass notch and said second bypass notch themselves providing space sufficient to accommodate the optical cables of said series of at least two optical sensor lenses.

7. The system of mounting a series of at least two optical sensor lenses of claim 5, further comprising;
a cover plate located over each said view aperture, each said cover plate having a at least one sight aperture, wherein each said lens mount in each said mounting block is aligned with a sight aperture.

8. The system of mounting a series of at least two optical sensor lenses of claim 5, wherein;
said cover plate is removably attached to said section of hollow tube with fasteners.

9. The system of mounting a series of at least two optical sensor lenses of claim 7, wherein;
said cover plate has a fastener aperture through it and said mounting block has a fastener hole in it and said mounting block is held to said cover plate by a fastener.

10. The system of mounting a series of at least two optical sensor lenses of claim 5, further comprising;
a box mounted over said mounting block and said access aperture.

11. The system of mounting a series of at least two optical sensor lenses of claim 5, wherein;
said section of frame tubing is maintained with positive air pressure.

12. The system of mounting a series of at least two optical sensor lenses of claim 5, wherein;
each said mounting block is at least partially located within said frame tubing.

13. A method of mounting one sensor lens among a series of at least two sensor lenses within a section of frame tubing, wherein each said sensor lens has an optical cable leading to said sensor lens, said method of mounting said one sensor lens comprising;
cutting a view aperture in the wall of said frame tubing;
cutting an access aperture in the wall of said frame tubing generally aligned with said view aperture, said access aperture having a pair of notches in its perimeter;
mounting a mounting block at said access aperture, said mounting block having a lens mount for said sensor lens said lens mount being aligned with said view aperture;
routing said series of sensors lenses and cables through said frame tubing to said mounting block and behind said mounting block between a first edge of said access aperture and a first edge of said mounting block;
separating said one sensor lens out from among said series of sensor lenses and mounting said one sensor lens in said lens mount in said mounting block, and;
routing the remaining sensor lenses and cables of said series back into said frame tubing between a second edge of said mounting block and a second edge of said access aperture through the other of said notches in said perimeter of said mounting plate aperture.

14. The method of claim 13, further comprising;
cutting a bypass notch in said first edge of said access aperture and cutting a bypass notch in said second edge of said access aperture, each said bypass notch sufficient to accommodate said cables of said sensor lenses.
